(19) United States
(12) Patent Application Publication
(10) Pub. No.: US 2008/0038607 A1
(43) Pub. Date: Feb. 14, 2008

(54) Flow rate sensor and fuel cell system with flow rate sensor

(76) Inventors: Won Hyouk Jang, Yongin-si (KR); Do Young Kim, Yongin-si (KR); Joon Soo Bae, Yongin-si (KR); Min Jung Oh, Yongin-si (KR); Sang Min Jeon, Pohang-si (KR)

Correspondence Address: ROBERT E. BUSHNELL, 1522 K STREET NW, SUITE 300, WASHINGTON, DC, 20005-1202, US

(21) Appl. No.: 11/889,479

(22) Filed: Aug. 14, 2007

(30) Foreign Application Priority Data
Aug. 14, 2006 (KR) 10-2006-0076784

(51) Int. Cl. H01M 8/04

(52) U.S. Cl. 429/24; 429/25

(57) ABSTRACT

A flow rate sensor includes a collision sensing plate and a variable resistance unit. The collision sensing plate is positioned in a flow path of the fluid and is bent with a different degree depending on a flow rate of the fluid. The variable resistance unit is connected to the collision sensing plate, and varies resistance depending on the degree of the bend of the collision sensing plate. A fuel cell system with the flow rate sensor is capable of measuring the flow rate of fluid such as fuel with an inexpensive cost and in a manner of not substantially interrupting the flow of the fluid.

### CROSS-REFERENCE TO RELATED APPLICATIONS AND CLAIM OF PRIORITY

This application claims the benefit of Korean Patent Application No. 2006-0076784, filed on Aug. 14, 2006, in the Korean Intellectual Property Office, the disclosure of which is incorporated herein by reference.

### BACKGROUND

1. Field of the Invention

The present invention relates to a fuel cell system with a flow rate sensor.

2. Discussion of Related Art

A fuel cell is a power generation system that generates electricity by a balanced electro-chemical reaction of fuel such as hydrogen which may be contained in hydrocarbon-based substance such as methanol, ethanol and natural gas, or pure hydrogen, and oxygen in the air.

Fuel cells are generally classified according to the type of electrolyte used. Fuel cells can be divided into a phosphoric acid fuel cell, a molten carbonate fuel cell, a solid oxide fuel cell, a polymer electrolyte membrane fuel cell and an alkaline fuel cell, etc. These respective fuel cells are operated on the same basic principle, but are different in view of types of fuels used, operating temperatures, catalysts and electrolytes, etc.

Among others, the polymer electrolyte membrane fuel cell (PEMFC) has advantages of a remarkably high output feature, a low operating temperature feature, and a rapid starting and answering feature over other types of fuel cells, and is widely applicable to a mobile power source such as portable electronic equipment or a transportable power source such as a power source for an automobile as well as a distributed power source such as a stationary power plant used in a house and a public building, etc. The polymer electrolyte membrane fuel cell performs the power generation using fuel in gas phase (mainly, a hydrogen molecule). It is preferable that the polymer electrolyte membrane fuel cell includes a driving controller measuring or controlling amounts of fuel supply and production amounts of by-products of power generation to effectively operate the fuel cell.

Also, as a fuel cell, there is a direct methanol fuel cell (DMFC), which is similar to the polymer electrolyte membrane fuel cell in that they both use a polymer membrane as the electrolyte, but, in the direct methanol fuel cell, the anode catalyst itself draws the hydrogen from a liquid methanol, eliminating the need for a fuel reformer.

The direct methanol fuel cell includes, for example, a stack, a fuel tank and a fuel pump, etc. The stack generates electric energy by electro-chemically reacting fuel containing hydrogen with an oxidizer such as oxygen or air, etc. The stack has a structure that several to several tens of unit fuel cells, which are each typically composed of a membrane electrode assembly (MEA) and a separator, are stacked. The membrane electrode assembly has a structure having an anode (namely, “fuel electrode” or “oxidation electrode”), a cathode (namely, “air electrode” or “reduction electrode”), and a polymer electrolyte membrane therebetween.

Fuel cells such as a direct methanol fuel cell in which liquid fuel is supplied to a stack show a great difference in the driving efficiency thereof, depending on a concentration (e.g., mol concentration) of fuel supplied to an anode and a cathode. For example, when the mol concentration of fuel supplied to the anode is high, the amount of the fuel transferring from the anode to the cathode is increased due to a limit of the currently available polymer electrolyte membrane and thus, counter electromotive force is generated due to the fuel reacted on the cathode, decreasing the power output. Accordingly, the fuel cell stack has optimal driving efficiency in the predetermined fuel concentration according to the construction and property thereof. Therefore, in the direct methanol fuel cell system the concentration of fuel should be properly controlled.

Therefore, the direct methanol fuel cell, etc. can include a device for measuring the concentration of a solution stored in equipment such as a stack, a fuel tank and a recycle tank, or the concentration of a solution flowing within pipes of the equipment. The fuel cell can estimate the driving state of the fuel cell system by measuring the concentration of solutions such as fuel, products, etc., and can improve the driving efficiency of the fuel cell by controlling each constituent constituting the fuel cell system according to the result of the estimation.

In order to more greatly improve the effects of the concentration measurement, it is possible to measure the flow rate of fluid (fuel, emitted products) flowing in each constituent of the direct methanol fuel cell. Also, it is possible to measure the flow rate of fluid flowed in or out in order to calculate the amount of fluid, or measure the flow rate of fluid in order to estimate the concentration without a direct measurement. Also, in the polymer electrolyte membrane fuel cell, a measurement of the flow rate of fluid (fuel, emission) of gas phase or liquid phase may be required for the similar reasons.

A flow rate sensor for the fuel cell system should be small and inexpensive, and the accuracy of measurement should be guaranteed, not interrupting the flow of fluid. However, various flow rate sensors, which have been presented up to now, have failed to satisfy those requirements.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an improved flow rate sensor.

The present invention provides an improved fuel cell including a flow rate sensor.

The present invention provides a fuel cell with an inexpensive flow rate sensor enabling the accurate measurement of the flow rate of fluid in the fuel cell system.

The present invention provides a fuel cell with a flow rate sensor enabling accurate measurement of the flow rate of fluid, not interrupting the flow of fluid.

According to an aspect of the present invention, a flow rate sensor is constructed with: a collision sensing plate to be positioned in a flow path of fluid and being bent with a different degree depending on a flow rate of the fluid; and a variable resistance unit connected to the collision sensing plate, the variable resistance unit varying resistance depending on the degree of the bend of the collision sensing plate.

According to another aspect of the present invention, a flow rate sensor is constructed with: a sensing unit comprised of: a collision sensing plate to be positioned in a flow path of fluid and being bent with a different degree depending on a flow rate of the fluid; and a variable resistance unit connected to the collision sensing plate, the variable resistance unit not being in directly contact with the fluid, the variable resistance unit varying resistance depending on the degree of the bend of the collision sensing plate; and a resistance measuring unit measuring the resistance of the variable resistance unit.

According to still another aspect of the present invention, a flow rate sensor is constructed with: a stack generating electric energy by an electro-chemical reaction between fuel and oxidizer; a fuel supplier supplying the fuel to the stack; an oxidizer supplier supplying the oxidizer to the stack; a flow rate sensor mounted in a flow path of the fuel cell, the flow rate sensor comprising: a sensing unit comprising a collision sensing plate positioned in the flow path of the fluid and being bent with a different degree depending on a flow rate of the fluid, and a variable resistance unit connected to the collision sensing plate and varying resistance depending on the degree of the bend of the collision sensing plate; and a driving controller for controlling an operation of the fuel cell system depending on the flow rate of the fluid.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view showing one embodiment of a cantilever flow rate sensor according to the present invention; and

FIG. 2 is a system construction view showing a fuel cell system on which a cantilever flow rate sensor as shown in FIG. 1 can be mounted.

### DETAILED DESCRIPTION OF EMBODIMENTS

Hereinafter, embodiments of the present invention will be described in a more detailed manner with reference to the accompanying drawings. However, the present invention is able to be implemented as various modifications and is not limited to the embodiments described herein.

In the instant application, the meaning of measuring resistance may include measuring the resistance in a resistance unit such as ohm, etc., measuring the voltage value of both ends of variable resistance when current of a predetermined size is flowed to the variable resistance, or measuring the current value flowing when the predetermined voltage is given to the both ends of variable resistance. In other words, even though any measuring unit factor corresponding to the resistance value of variable resistance is used, it is included in the resistance measurement disclosed in the present invention.

According to an embodiment of the present invention, a flow rate sensor may include a sensing unit which senses the fluid and a flow rate calculating unit which calculates the flow rate from the measurement of the sensing unit.

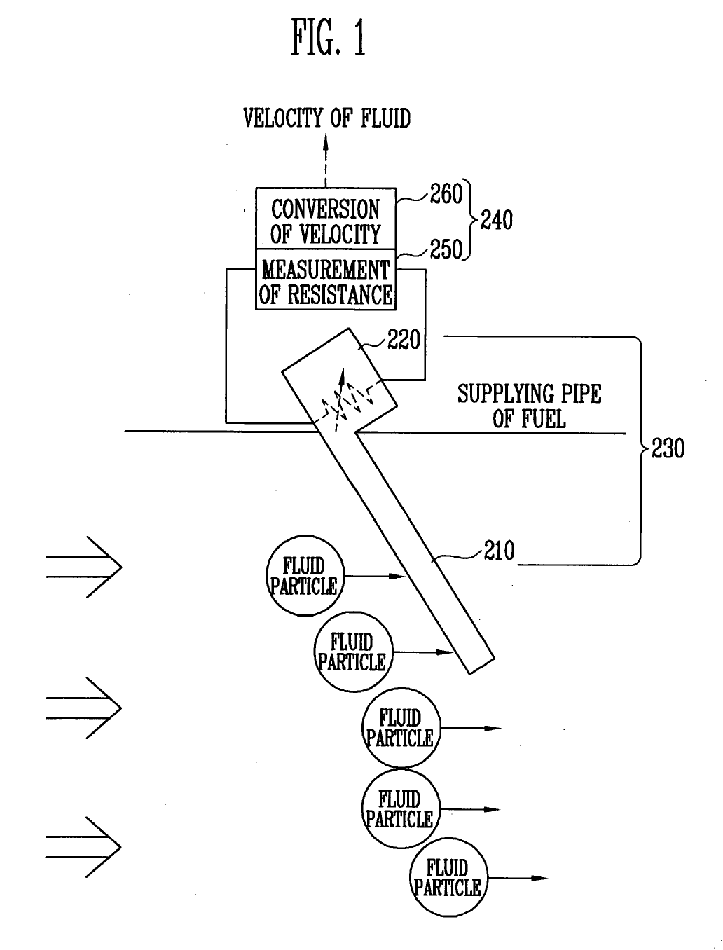

According to an embodiment of the present invention, the sensing unit of the flow rate sensor may have a cantilever type structure as shown in FIG. 1. Hereinafter, the flow rate sensor having a sensing unit of a cantilever type structure is referred to as a cantilever flow rate sensor.

FIG. 1 shows an example of an active cantilever flow rate sensor. As illustrated in FIG. 1, the cantilever flow rate sensor includes a sensing unit 230 which includes a collision sensing plate 210 dipped in fluid to be sensed and a variable resistance unit 220 which are integrally formed; and a flow rate calculating unit 240 for calculating a flow rate of the fluid from the resistance value of the variable resistance unit 220.

If the collision sensing plate with a sufficiently thin thickness is positioned on a flow path in a state of slightly interrupting the flow of fluid, the collision sensing plate becomes to be somewhat bent depending on the flow of fluid. At this time, the degree of the bend is in proportion to the flow rate of the fluid flowing to the circumstance of the sensing plate. The resistance value of the variable resistance unit 220 becomes different depending on the degree of the bend so that the resistance value of the variable resistance unit 220 depending on the flow rate of fluid can be obtained.

It is preferable that the variable resistance unit 220 is installed in a state of being inclined to the flow direction of fluid. In the specification and the claims, when it is said that the variable resistance unit 220 or the collision sensing plate 210 is inclined to the flow direction of fluid, it means that the variable resistance unit 220 or the collision sensing plate 210 is inclined to the direction as illustrated in FIG. 1. When it is installed in a different direction from the illustrated direction, although sensing sensitivity may be enhanced, the mechanical durability of the sensing plate may be deteriorated.

The flow rate calculating unit 240 connected to the variable resistance unit 220 may include: a resistance measuring unit 250 for measuring resistance of the variable resistance unit; and a flow rate converter 260 for converting the resistance value measured in the resistance measuring unit 250 into a flow rate of the fluid. The resistance measuring unit 250 may output electrical physical quantity (e.g., voltage or current) being in proportion to the resistance value of the variable resistance unit 220. The flow rate converter 260 receives the resistance value from the resistance measuring unit 250 and converts the peak value (the maximum value, the minimum value, and/or the average value) of the resistance value to the flow rate of the fluid.

In view of modularization of components, since converting the resistance value to the flow rate of fluid becomes greatly different depending on whether the fluid is in a gas phase or a liquid phase and the density of the fluid, it is preferable that the collision sensing plate 210 and the variable resistance unit 220 are formed in a single body. It is also preferable that the resistance measuring unit 250 is formed in a single body with the collision sensing plate 210 and the variable resistance unit 220, and the flow rate converter 260 is implemented to be performed in a computation apparatus (e.g., a controller) of a system on which a module of the sensing unit is installed, rather than is formed in a single body with the resistance measuring unit 250. In this case, the resistance measuring unit 250 generates the voltage or current in proportion to the resistance value of the variable resistance unit 220 and performs a role of a buffer for transmitting it to the computation apparatus of the system.

The flow rate converter 260 can convert the resistance value outputted from the resistance measuring unit 250 into the flow rate with a predetermining equation or a conversion table. In order to obtain a more accurate flow rate, the effects of other factors such as a temperature of the fluid or a density of the fluid can be considered in a converting process.

When the consideration of those factors is simplified, different conversion tables can be used depending on the positions of the flow rate sensor. That is, in order to simplify the factors such as temperature of the fluid or the density of fluid, the factors are assumed to have a predetermined value according to the positions of the flow rate sensor. In this case, the flow rate converter 260 includes resistance-flow rate conversion tables with different data depending on the positions on which the flow rate sensor is installed, and converts the resistance value into the flow rate value by using the resistance-flow rate conversion tables.

When considering a temperature factor, a temperature sensor may be further installed with or around the flow rate sensor, and the temperature value sensed from the temperature sensor can be inputted into the flow rate sensor. For example, the flow rate calculating unit 240 may further include a temperature sensor for measuring the temperature of a position on which the fluid flow rate sensor installed, and the flow rate converter 260 calculates the fluid flow rate depending on the measured resistance and the measured temperature. For this end, the flow rate converter 260 includes a temperature/resistance-flow rate conversion table and uses it to obtain the fluid flow rate.

Next, an installation position of the flow rate sensor and an application process of the flow rate value in a fuel cell system will be described. In the following description, the term ‘non-reactive fuel’ means fuel which is not reformed into a hydrogen gas and exhausted from the stack together with water (H₂O) generated while reforming the fuel containing hydrogen into a hydrogen gas in a stack of the fuel cell system; the term ‘raw material’ means a high concentration of fuel such as a hydrocarbon-based fuel (e.g., methanol, ethanol and natural gas); and the term ‘fuel containing hydrogen’ means fuel supplied to a reformer or a stack.

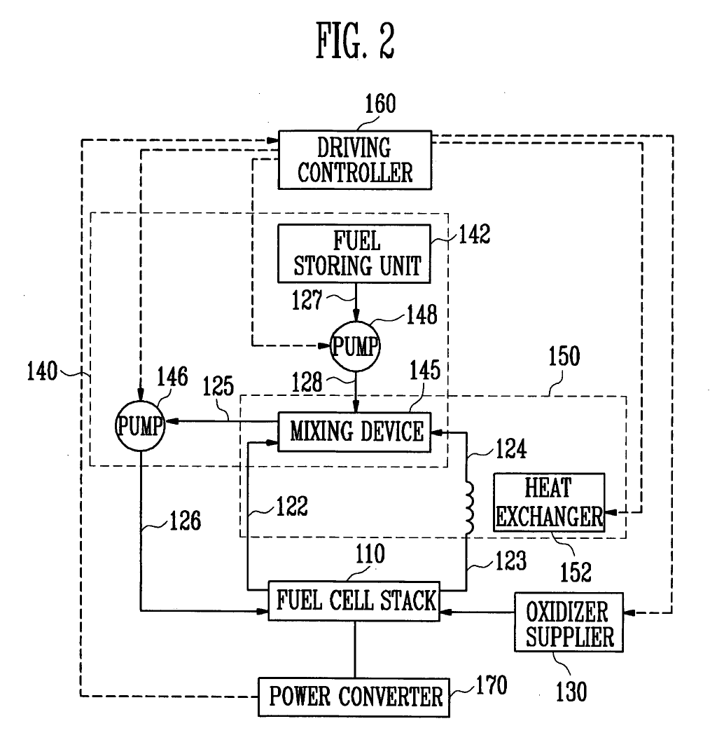

FIG. 2 illustrates a general direct methanol fuel cell system on which a flow rate sensor according to an embodiment of the present invention can be installed. However, the illustrated structure is not limited to the fuel cell system using methanol as fuel but it is applicable to a fuel cell system wherein fuel in a state of a water solution is supplied to a stack, such as a fuel cell using ethanol and acetic acid as fuel.

As illustrated in FIG. 2, a direct methanol type fuel cell includes: a stack 110 generating electricity by an electro-chemical reaction between fuel (e.g., a hydrogen gas) and an oxidant (e.g., oxygen gas); a fuel storing unit 142 where fuel to be supplied to the stack 110 is stored; an oxidizer supplier 130 for supplying oxidizer to the stack 110; a heat exchanger 152 recovering the effluent exhausted from the stack 110; and a mixing device 145 (or a mixing tank) mixing the effluent fuel exhausted from the heat exchanger 152 and the fuel cell stack 110 with the fuel exhausted from the fuel storing unit 142 to supply raw material containing hydrogen to the stack 110. Non-reacted fuel returns to mixing device 145 from anode of the fuel cell stack 110 through the pipe 122. Considerable amount of the effluent from cathode of the fuel cell stack 110 passes in forms of vapor through the pipe 123 and in forms of liquid through the pipe 124. Here, the heat exchanger 152 and the mixing device 145 constitute an effluent processor 150 processing the effluent of the stack, and the fuel storing unit 142, the mixing device 145 and pumps 146 and 148 constitute a fuel supplier 140.

The stack 110 is provided with a polymer membrane and a plurality of unit cells including a membrane electrode assembly (MEA) which is composed of a cathode and an anode provided with on both of the polymer membrane. The anode oxidizes hydrogen gas generated by reforming the fuel containing hydrogen supplied from the fuel supplier 140 to generate a hydrogen ion (H⁺) and an electron (e⁻). The cathode converts oxygen in the air supplied from the oxidizer supplier 130 into an oxygen ion and an electron. And, the hydrogen ion generated from the anode on the polymer membrane is provided to the cathode. The protons are conducted through the polymer membrane to the cathode, but the electrons are forced to travel in an external circuit (supplying power) because the polymer membrane is electrically insulating, and the fuel cannot pass through the polymer membrane to the cathode. The polymer electrolyte membrane may have a thickness of about 50 to 200 μm.

The electric energy generated from a chemical reaction between hydrogen gas and oxygen in the unit cell is converted into current and voltage, etc. to meet a standard size through a power converter 170, and outputted. According to an implementation, the output of the power converter can have a structure to charge a second cell separately equipped, and a structure to supply power to a driving controller 160.

Non-reactive fuel where carbon dioxide CO₂ and water H₂O are mixed moves to a condensing unit of the heat exchanger 124 through an outlet, and the non-reactive fuel condensed in the condensing unit is collected by the mixing device 145. The carbon dioxide contained in the non-reactive fuel can flow out from the mixing device to the outside thereof. After mixing the non-reactive fuel collected in the mixing device 50 with the fuel supplied from the fuel storing unit 142, they are supplied to the anode of the stack 110.

The oxidizer supplier 130 can be an air supplier for supplying air as an oxidizer. The oxidizer supplier 130 can be an active driving pump for supplying air to the cathode of the stack 110 or a passive vent with a structure that the flow of air is simply smooth.

The driving controller 160 is provided to control the operations of a driving pump 148 for the fuel storing unit 142, and a pump 146 supplying the fuel from the mixing device 145 to the stack 110. In addition to the pumps as described above, additional pumps can be optionally installed in a pipe 123 between the fuel cell stack 110 and the heat exchanger 152, a pipe 124 between the heat exchanger 152 and the mixing device 145, a pipe 122 between the fuel cell stack 110 and the mixing device 145, and the inside of the oxidizer supplier 130, and the driving controller 160 can control the operations of each pump installed.

It is preferable that the driving controller 160 includes a digital processor, and in this case the digital process has a structure that a reference clock for an operation is inputted. The processing load of the driving controller 160 and the processing load of a flow rate calculating unit (240 in FIG. 1) of a flow rate sensor according to the embodiment of the present invention are not so much, and one processor can process the operation of the driving controller 160 and the flow rate calculating unit 240.

The flow rate sensor according to an embodiment of the present invention can be installed on the flow path of liquid phase fluid, such as a pipe 123 between the cathode and the heat exchanger 152, a pipe 124 between the heat exchanger 152 and the mixing device 145, a pipe 122 between the anode and the mixing device 145, a pipe 127 or 128 between the fuel storing unit 142 and the mixing device 145, and an input/output pipe 125 and 126 of the pump 146, etc., and it can be installed on the flow path of gas phase fluid such as oxidizer or exhausting gas of the stack. For example, the sensor can be fixed in the molding process of a pipe or the sensor can be fitted in a hole of a pipe. The hole may be sealed after install of the sensor. Exemplary material for forming the collision sensing plate 210 is solid silicon.

When a cross sectional area of a pipe is known and the flow rate of fluid is measured, the amount of flowing in/flowing out of fluid per unit time can be calculated by multiplying the cross sectional area by the flow rate of fluid. The result of calculating the amount of flowing in/flowing out of fluid can be applied in various methods for stabilizing the driving of a fuel cell system. For example, it can be used in maintaining a concentration of the fuel within a mixing device of a direct fuel cell system.

When the concentration of the fuel supplied from the fuel storing unit 142 is constant, and the concentration of effluent from the stack is constant while operating the fuel cell stack within a predetermined temperature range, the driving controller 160 calculates a concentration of the fuel flowed into the mixing device 145 from the beginning of driving of a fuel cell and an amount of the effluent from the fuel cell stack 110, and controls the amount of the fuel supplied from the fuel supplying unit 142 and the amount of the effluent from the fuel cell stack 110 to keep the concentration of the fuel within the mixing device 145 constant.

According to an embodiment of the present invention, the flow rate sensor according to an embodiment of the present invention may be installed on a fuel supplying pipe 126 to the stack, and the driving controller 160 minutely controls the amount of fuel supplied to the stack to enhance driving efficiency of the stack. To this end, an operation of the pump 146 and/or 148 can be controlled depending on a flow monitoring simply using the measured flow rate; and, alternatively, the operation of the pump 146 and/or 148 can be controlled in the manner of feedback.

The latter can be a countermeasure against the case that the pumping amount of the pump is not constant. In the case of a fuel pump such as a diaphragm pump, there is a tendency that the pumping amount of one-time pumping is decreased as time elapses. The flow rate sensor according to an embodiment of the present invention may be installed on an outlet of the pump 148 or the pipe 128 connected to the outlet to measure the flow rate of fluid flowing thereon so that the driving controller 160 can calculate the pumping amount of one-time pumping of the fuel pump 148. If the pumping amount of one-time pumping of the fuel pump 148 is calculated, the driving controller 160 determines the operating frequency of the fuel pump 148 by applying the calculated pumping amount of one-time pumping in supplying fuel. Also, this control can be applied to all other pumps within a fuel cell as well as, or alternatively, the fuel pump 148.

The flow rate sensor according to an embodiment of the present invention is useful in measuring not only the flow rate of liquid phase fluid but also the flow rate of gas phase fluid. It can be applied to measuring of a flowing amount in a polymer electrolyte membrane fuel cell which uses gas-phase fuel or in a direct methanol fuel cell. The flow rate sensor can be used to control the driving efficiency of the stack by measuring the flowing amount of gas phase fuel into a stack, and to examine the reforming efficiency by measuring the amount of a generated reforming gas when a reformer is provided. Also, the flow rate sensor can be applied to monitor the extent of an operation of the stack by measuring the flow of the effluent gas of the cathode of the stack.

A fuel cell system according to an embodiment of present invention is capable of measuring the flow rate of fluid such as fuel with an inexpensive cost and in a manner of not substantially interrupting the flow of the fluid.

Also, since the size of the cantilever flow rate sensor can be miniaturized, a small-sized fuel cell system which has a high driving efficiency can be constructed.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel cell system, comprising:
a stack generating electric energy by an electro-chemical reaction between fuel and oxidizer;
a fuel supplier supplying the fuel to the stack;
an oxidizer supplier supplying the oxidizer to the stack;
a flow rate sensor comprising:
a sensing unit comprising a collision sensing plate positioned in the flow path of fluid and being bent with a different degree depending on a flow rate of the fluid, and a variable resistance unit connected to the collision sensing plate and varying resistance depending on the degree of the bend of the collision sensing plate; and
a driving controller for controlling an operation of the fuel cell system depending on the flow rate of the fluid.

2. The fuel cell system as claimed in claim 1, wherein the collision sensing plate and the variable resistance unit are formed in a single body.

3. The fuel cell system as claimed in claim 1, wherein the sensing unit is inclined to the direction of the fluid.

4. The fuel cell system as claimed in claim 1, wherein the flow rate sensor further includes a flow rate calculating unit calculating the flow rate of the fluid from the resistance of the variable resistance unit.

5. The fuel cell system as claimed in claim 4, wherein the flow rate calculating unit comprises:
a resistance measuring unit for measuring the resistance of the variable resistance unit; and
a flow rate converter for converting the resistance value measured in the resistance measuring unit into the flow rate of the fluid.

6. The fuel cell system as claimed in claim 5, wherein the flow rate calculating unit further comprises a temperature sensor installed adjacent to the flow rate sensor for measuring a temperature of the fluid passing the flow rate sensor and transferring the measured temperature value to the flow rate converter, and the flow rate converter calculates the flow rate in consideration of the temperature value.

7. The fuel cell system as claimed in claim 5, wherein the flow rate converter includes a resistance-flow rate conversion table with different data depending on positions on which the flow rate sensor is installed.

8. The fuel cell system as claimed in claim 1, wherein the fuel cell system includes a mixing device mixing non-reactive fuel exhausted from the stack and the fuel exhausted from the fuel supplier to supply raw material containing hydrogen to the stack, and the flow rate sensor is installed to detect the flow rate of the fluid entering the mixing device and the flow rate of the fluid flowing out of the mixing device.

9. The fuel cell system as claimed in claim 1, wherein the flow rate sensor is installed within a pipe supplying the fuel to the stack.

10. The fuel cell system as claimed in claim 1, wherein the fuel cell system further includes an effluent processor for removing or recycling effluent of the stack.

11. The fuel cell system as claimed in claim 1, wherein the fuel supplier comprises a pump for forcing the fuel to flow to the mixing device, and the flow rate sensor is installed around an outlet of the pump in the fuel cell system, and the driving controller calculates a pumping amount of one-time pumping of the pump by using the flow rate measured by the flow rate sensor and determines an operating frequency of the pump by applying the calculated pumping amount of one time pumping of the pump.
